(19) United States
(12) Patent Application Publication
(10) Pub. No.: US 2014/0281621 A1
(43) Pub. Date: Sep. 18, 2014

(54) STEALTH POWER MANAGEMENT IN STORAGE ARRAY

(71) Applicant: Jay Everett Nelson, Superior, CO (US)

(72) Inventor: Jay Everett Nelson, Superior, CO (US)

(21) Appl. No.: 13/831,719

(22) Filed: Mar. 15, 2013

(51) Int. Cl. G06F 1/32

(52) U.S. Cl. CPC G06F 1/3275
USPC 713/323

(57) ABSTRACT

Increased power savings is provided by powering down idle storage devices and emulating storage device responses to host requests which do not require data access. A virtual target emulates the hard disk drive, has information associated with the hard disk drive, and provides information in response to host requests to satisfy the host. For host requests that do require data access, the storage device is powered on and storage device control is provided to the host. If the storage device is not ready to communicate with a host, a virtual target communicates with the host to emulate the storage device and prevent the host from timing out while the storage device is powering up to get ready.

### BACKGROUND OF THE INVENTION

1. Field of the Invention

The present storage system power management. More specifically, the claimed invention relates to power management in a storage array using virtual targets.

2. Description of the Related Art

As companies create and use more data, the need for power efficient data storage solutions has increased. Most hard disk drives have a standby state that allows them to consume less power after being idle for some period of time. This helps data storage centers consume less power be reducing the time that the hard disk drives are spinning—and hence drawing power.

When an idle disc drive is accessed or queried, for whatever reason, it typically powers itself back on. With all the maintenance and status checks as well as other operations performed with hard disk drives, most drives do not stay idle for very long in data storage environments. This reduces the power savings realized by data centers.

Further, even when in standby mode, drives use energy. In large data centers with mass quantities of drives, this power usage even from idle hard disk drives adds up to a considerable amount. What is needed is a system which provides improved power savings in data storage systems.

### SUMMARY OF THE CLAIMED INVENTION

The present invention provides increased power savings by powering down idle storage devices and emulating storage device responses to host requests which do not require data access. A virtual target emulates the hard disk drive, has information associated with the hard disk drive, and provides information in response to host requests to satisfy the host. For host requests that do require data access, the storage device is powered on and storage device control is provided to the host. If the storage device is not ready to communicate with a host, a virtual target communicates with the host to emulate the storage device and prevent the host from timing out while the storage device is powering up to get ready.

In an embodiment, a method for managing power of a storage device may begin with detecting a storage device of a plurality of storage devices in a storage enclosure is in a standby state or, if standby is not supported by the storage device, the storage device exceeding a programmable inactivity period. A first request is received from a host for the storage device that does not require access to data on the storage device. A response is transmitted that resolves the first request to the host by a virtual target. A second request is received from the host for the storage device that requires access to data on the storage device. The storage device is set to a power-on state and the second request is processed by the storage device.

### BRIEF DESCRIPTION OF THE DRAWINGS

FIG. 1 is a block diagram of a data storage system.

FIG. 2 is a block diagram of an SAS expander.

FIG. 3 is a flowchart of a method for emulating a storage device.

FIG. 4 is a flowchart of a method for processing a host request for storage device access.

FIG. 5 illustrates a computing system 500 that may be used to implement a host for use with the present technology.

### DETAILED DESCRIPTION

The present invention provides increased power savings by powering down idle storage devices and emulating storage device responses to host requests which do not require data access. A virtual target emulates the hard disk drive, has information associated with the hard disk drive, and provides information in response to host requests to satisfy the host. For host requests that do require data access, the storage device is powered on and storage device control is provided to the host. If the storage device is not ready to communicate with a host, a virtual target communicates with the host to emulate the storage device and prevent the host from timing out while the storage device is powering up to get ready.

FIG. 1 is a block diagram of a data storage system. The data storage system of FIG. 1 includes host 100, network 120, and storage enclosure 130. Host 100 may be implemented by one or more computing devices which utilize storage device 120 for storage purposes. Network 120 may be a public or private network, the internet, an intranet, another network, or some combination of networks.

Storage enclosure 130 may be one of many enclosures that implement a data center. Storage enclosure 130 includes SAS expander 140 and storage device 150. Storage device 150 may include one or more hard discs or other storage devices used to store files and other information for a host 100. SAS expander 140 may be implemented with a processing system which controls hard drive operation and power states and carries out host requests on storage device 150.

Storage enclosure 130 may include additional components. The limited components illustrated in FIG. 1 are for purposes of discussion only. It should be understood that a storage enclosure 130 may include other components as required to provide a data storage system for access by a host 100, including components such as for example one or more processors, input devices, output devices, networking devices, fans and cooling systems, servers, circuitry for operation, and other components.

FIG. 2 is a block diagram of an SAS expander. The SAS expander of FIG. 2 includes virtual initiator (SSP) 205, virtual initiator (STP) 208, virtual target 210, storage device manager 220, storage device status list 230, and storage device information 240. Virtual target 210 may include a program which emulates a storage device when the storage device is powered off. Virtual target 210 may receive requests from a host and generate and transmit responses to the host in place of the storage device. The responses may be such that the host will not require any further information and receive “the response it wants to hear.”

Storage device manager 220 may monitor storage devices, and set the power state of storage devices. Storage device manager may detect those storage devices that are idle and set their power state to off. Storage device status list 230 may include a list of power statuses for hard drives as detected by a storage device manager 220. Storage device information 240 may include data retrieved from a storage device just before it is powered down by storage device manager 220. The storage device information collected from a Storage Device may include information specific to the storage device which shall be required to respond to a host issuing commands that are allowed for in the SCSI Primary Commands specification when a device is in the Standby State-Inquiry, Log Select, Log Sense, Mode Select, Mode Sense, Report LUNs, Receive Diagnostic Results, Send Diagnostic, Report Target Port Groups, Set Target Port Groups, Request Sense, Persistent Reserve In, Persistent Reserve Out, Echo buffer modes of Read Buffer and Echo buffer modes of Write Buffer. At no time will user information stored on the disk be read by the Storage Device Manager. In the event the host requests information that requires physical access to the Storage Medium the Storage Device must be transitioned to the Power On State.

SAS expander 200 may be implemented as a processor on a chip or other processing system. The SAS expander may include processors and memory, which are not illustrated in FIG. 2 for purposes of illustration. Programs may be stored in SAS expander memory and executed by the processor to perform the functionality described herein.

FIG. 3 is a flowchart of a method for emulating a storage device. First, a storage device is detected in standby mode at step 305. The storage device detection may be performed by an SAS expander in communication with the storage device. Storage device information may be accessed by a virtual initiator (Either through the SSP Virtual Intiator or the STP Virtual Initiator depending on the supported protocol of the Storage Device) at step 310. The virtual target, and virtual initiators may reside and be executed within the SAS expander 200 and the virtual initiators may retrieve information from the drive that a host may require to process host requests other than file data itself at step 306. A critical step required to achieve the ‘Stealth’ nature of this algorithm is to completely mask the change in the state of the drive from the host and this requires that the Connection Manager Zone Masks be set to mask Broadcast Change Events from the host when the Storage Device goes offline at step 307. The final step involves re-routing any requests from the host to the Storage Device by means of configuring the Routing Table in the Expander to Route requests targeted at the Storage Device to the Virtual Target at step 308. The storage device in a standby state or has exceeded a pre-determined time period with no activity from the host is powered off at step 315. Next, a determination is made as to whether a host request is received at step 320. If no host request is received, the method of FIG. 3 returns to step 320. If a host request is received, a determination is made as to whether the request requires storage device access at step 325. The request may require storage device access if the request is to produce a file which requires access of data from the storage device. Other requests, such as maintenance requests, pings, blink device requests and others do not require storage device access. If the request requires storage device access at 325, the request is processed by an SAS expander at step 330. Processing this request requires that the device be powered on and eventually the device control are handed over to the host. Processing requests by an SAS expander is discussed in more detail below with respect to the method of FIG. 4.

If the request does not require storage device access, the request may be generated and transmitted by a virtual target at step 335. The virtual target may generate the response to the request at least in part from the storage device information retrieved at step 310. In some embodiments, the virtual target may be implemented by a thread in the firmware operation system of the SAS expander processing system. After generating and transmitting the response, the method of FIG. 3 returns to step 320.

FIG. 4 is a flowchart of a method for processing a host request for storage device access. The method of FIG. 4 provides more detail for step 330 of the method of FIG. 3. First, the storage device is transitioned to a power on state at step 310. The power on state may be triggered by the SAS expander. Next, a determination is made as to whether the host requires a response from the storage device at step 320. It may take a bit of time for the storage device to completely power up and be able to communicate with the host. In this case, if the host requires a response before the storage device is ready, a response may be generated and transmitted to the host by the virtual target at step 330. Again, the virtual target may create the response to the host based on the storage device information accessed earlier. If no response is required immediately for the host, the method of FIG. 4 continues to step 340 where a determination is made as to whether the storage device is ready to communicate with the host. If the storage device is not ready to communicate with the host, the method of FIG. 4 returns to step 320. If the storage device is ready to communicate with the host, storage device control is provided to the host at step 350 where the Routing Table Entry for the Storage Device is deleted and all further communication with the Storage Device is performed between the Host and the Storage Device. The host may then access data from the storage device and control the storage device.

FIG. 5 illustrates a computing system 500 that may be used to implement a host for use with the present technology. The computing system 500 of FIG. 5 includes one or more processors 510 and memory 520. Main memory 520 stores, in part, instructions and data for execution by processor 510. Main memory 520 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 520 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 520.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD) or other suitable display device. Display system 570 receives textual and graphical information, and processes the information for output to the display device.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for managing power of a storage device, comprising:
detecting a storage device of a plurality of storage devices in a storage enclosure is in a standby state or has been inactive with respect to host access for a predetermined period of time;
receiving a first request from a host for the storage device that does not require access to data on the storage device;
transmitting a response that resolves the first request to the host by a virtual target;
receiving a second request from the host for the storage device that requires access to data on the storage device;
setting the storage device to a power-on state; and
processing the second request by virtual target and the storage device.

2. The method of claim 1, wherein the first request includes one of a storage device status request, write command, data duplication demand, and data deletion command.

3. The method of claim 1, wherein the second request includes a file access command.

4. The method of claim 1, further comprising:
accessing information stored on the storage device by the virtual initiator; and
generating the first request at least in part from the storage device information.

5. The method of claim 1, further comprising placing the storage device in a power-off state until the second request is received.

6. The method of claim 1, sending a response to the host by the virtual target after the storage device is set to a power-on state and before the storage device is ready to communicate with the host.

7. The method of claim 1, further comprising:
determining the storage device in the power-on state is ready to communicate with the host; and
providing the host with control of the storage device.

8. A computer readable non-transitory storage medium having embodied thereon a program, the program being executable by a processor to perform a method for managing power of a storage device, the method comprising:
detecting a storage device of a plurality of storage devices in a storage enclosure is in a standby state or has been inactive in terms of host access for a predetermined period of time;
receiving a first request from a host for the storage device that does not require access to data on the storage device;
transmitting a response that resolves the first request to the host by a virtual target;
receiving a second request from the host for the storage device that requires access to data on the storage device;
setting the storage device to a power-on state; and
processing the second request by virtual target and the storage device.

9. The computer readable non-transitory storage medium of claim 8, wherein the first request includes one of a storage device status request, write command, data duplication demand, and data deletion command.

10. The computer readable non-transitory storage medium of claim 8, wherein the second request includes a file access command.

11. The computer readable non-transitory storage medium of claim 8, further comprising:
accessing information stored on the storage device by the virtual initiator; and
generating the first response at least in part from the storage device information.

12. The computer readable non-transitory storage medium of claim 8, further comprising placing the storage device in a power-off state until the second request is received.

13. The computer readable non-transitory storage medium of claim 8, sending a response to the host by the virtual target after the storage device is set to a power-on state and before the storage device is ready to communicate with the host.

14. The computer readable non-transitory storage medium of claim 8, further comprising:
determining the storage device in the power-on state is ready to communicate with the host; and
providing the host with control of the storage device.
